(19) United States
(12) Patent Application Publication
(10) Pub. No.: US 2025/0075113 A1
(43) Pub. Date: Mar. 6, 2025

(54) HEAT-SEALING BARRIER CELLULOSE FILM, AND PREPARATION METHOD AND USE THEREOF

(71) Applicant: SHANDONG HENGLIAN NEW MATERIALS CO., LTD, Weifang (CN)

(72) Inventors: Kexuan Li, Weifang (CN); Xin Wang, Weifang (CN); Jinjiang Qiu, Weifang (CN); Chao Wang, Weifang (CN); Xiucai Jiang, Weifang (CN); Meng Li, Weifang (CN); Yuping Chen, Weifang (CN); Tuo Shi, Weifang (CN); Min Liu, Weifang (CN); Lianbo Li, Weifang (CN); Faguang Liu; Ruixian Yao, Weifang (CN)

(21) Appl. No.: 18/285,767

(22) PCT Filed: May 26, 2023
(86) PCT No.: PCT/CN2023/096422

§ 371 Date: Oct. 5, 2023

(30) Foreign Application Priority Data
Jun. 8, 2022 (CN) 202210642715.1

(51) Int. Cl. C09J 175/04; C08J 7/048; C09D 5/02; C09D 7/40; C09D 127/08; C09J 7/30; C09J 133/04

(52) U.S. Cl. CPC C09J 175/04; C08J 7/048; C09D 5/02; C09D 7/68; C09D 127/08; C09J 7/30; C09J 133/04; C09J 2301/122

(57) ABSTRACT

The present disclosure provides a heat-sealing barrier cellulose film, and a preparation method and use thereof. In the present disclosure, the heat-sealing barrier cellulose film includes a separation layer, a regenerated cellulose support layer, and an adhesive layer that are laminated in sequence. The separation layer is prepared from a barrier coating (including a polyvinylidene chloride (PVDC) emulsion, a first anti-sticking agent, and water); and the adhesive layer is prepared from an adhesive coating (an emulsion (including an acrylate emulsion and/or a polyurethane emulsion), a second anti-sticking agent, and water). The heat-sealing barrier cellulose film has high adhesion and barrier properties, can be directly heat-pressed with paper products, and shows a high adhesion strength with the paper products, thus meeting the requirements of bonding strength in coated paper. The heat-sealing barrier cellulose film shows high moisture resistance and oxygen resistance, and exerts excellent fragrance retention, freshness retention, and moisture resistance.

### CROSS REFERENCE TO RELATED APPLICATION

The present application claims priority to the Chinese Patent Application No. CN202210642715.1, filed to the China National Intellectual Property Administration (CNIPA) on Jun. 8, 2022 and entitled “HEAT-SEALING BARRIER CELLULOSE FILM, AND PREPARATION METHOD AND USE THEREOF”, all content of which is incorporated by reference herein in its entirety.

### TECHNICAL FIELD

The present disclosure relates to the technical field of functional cellulose films, in particular to a heat-sealing barrier cellulose film, and a preparation method and use thereof.

### BACKGROUND

The regenerated cellulose film prepared from natural cellulose shows biodegradability and environmental friendliness, and is an ideal environmental protection material.

The regenerated cellulose film is used as a support layer, and then coated with a solvent-based coating by dip coating or blade coating to obtain a cellulose film with heat-sealing and barrier properties. This cellulose film can meet the requirements of non-load-bearing application scenarios with a heat-sealing strength of not more than 350 g/37 mm.

With the continuous introduction of plastic ban on a global scale, the regenerated functional cellulose films applied across fields have become a hot demand in the packaging industry. However, an original heat-sealing strength limits use of this type of functional film in many applications, and cannot meet the needs of similar high-adhesion applications, such as the production of load-bearing packaging bags. This type of functional film also cannot replace the coated hot-melt adhesive-based plastic film to complete the manufacturing of paper-film composite packaging products.

### SUMMARY

In view of this, an objective of the present disclosure is to provide a heat-sealing barrier cellulose film, and a preparation method and use thereof. In the present disclosure, the heat-sealing barrier cellulose film has a high bonding strength with paper, and the heat-sealing barrier cellulose film shows a high self-bonding strength, thereby meeting the requirements of use. The cellulose film is applied to an aqueous emulsion coating, and has an environmental-friendly production process.

To achieve the above objective, the present disclosure provides the following technical solutions:

The present disclosure provides a heat-sealing barrier cellulose film, including a separation layer, a regenerated cellulose support layer, and an adhesive layer that are laminated in sequence; where
the separation layer is prepared from a barrier coating including a polyvinylidene chloride (PVDC) emulsion, a first anti-sticking agent, and water; and
the adhesive layer is prepared from an adhesive coating including an emulsion, a second anti-sticking agent, and water, and the emulsion includes an acrylate emulsion and/or a polyurethane emulsion.

Preferably, the regenerated cellulose support layer, the separation layer, and the adhesive layer are at a mass ratio of (77-87):(4-8):(9-15).

Preferably, the heat-sealing barrier cellulose film has a moisture content of 5% to 6%.

Preferably, the PVDC emulsion and the first anti-sticking agent in the barrier coating are at a mass ratio of 100:(1-3).

Preferably, the acrylate emulsion and the second anti-sticking agent in the adhesive coating are at a mass ratio of 100:(0.5-1.5).

Preferably, the regenerated cellulose support layer has a weight of 30 g/m² to 60 g/m².

The present disclosure further provides a preparation method of the heat-sealing barrier cellulose film, including the following steps:
coating both sides of the regenerated cellulose support layer with the barrier coating and the adhesive coating to form the separation layer and the adhesive layer, respectively, to obtain the heat-sealing barrier cellulose film.

Preferably, a process of coating the both sides of the regenerated cellulose support layer simultaneously includes the following steps: pumping the barrier coating and the adhesive coating into a first coating tank and a second coating tank by a pneumatic diaphragm pump, respectively, and then coating the both sides of the regenerated cellulose support layer simultaneously by an anilox roller.

Preferably, the anilox roller has an operating speed of 70 m/min to 95 m/min;
the anilox roller of the barrier coating has a mesh number of 100 mesh to 250 mesh, and the barrier coating has a dry coating weight of 3 g/m² to 5 g/m²; and
the anilox roller of the adhesive coating has a mesh number of 100 mesh to 180 mesh, and the adhesive coating has a dry coating weight of 4 g/m² to 7 g/m².

The present disclosure further provides use of the heat-sealing barrier cellulose film or a heat-sealing barrier cellulose film prepared by the preparation method in the field of packaging.

The present disclosure provides a heat-sealing barrier cellulose film, including a separation layer, a regenerated cellulose support layer, and an adhesive layer that are laminated in sequence; where the separation layer is prepared from a barrier coating including a PVDC emulsion, a first anti-sticking agent, and water; the adhesive layer is prepared from an adhesive coating including an emulsion, a second anti-sticking agent, and water; and the emulsion includes an acrylate emulsion and/or a polyurethane emulsion. The heat-sealing barrier cellulose film has high adhesion and barrier properties, can be directly heat-pressed with paper products, and shows high adhesion strength and mechanical strength with the paper products, thus meeting the requirements of bonding strength in coated paper to a certain extent. The heat-sealing barrier cellulose film shows high moisture resistance and oxygen resistance, and exerts excellent fragrance retention, freshness retention, and moisture resistance. The heat-sealing barrier cellulose film can also be heat-pressed by itself to form a packaging bag due to its high bonding strength, and the packaging bag exhibits a high edge-sealing strength and shows a desirable application prospect as a packaging material. As shown in test results in the examples, the heat-sealing barrier cellulose film provided by the present disclosure has a weight of (40-60) g/m², a longitudinal tensile strength of greater than 36 N/15 mm, a longitudinal elongation of greater than 18%, a bonding strength of the adhesive layer to a paper product of greater than 6 N/15 mm, a self-adhesion strength of the adhesive layer of greater than 7 N/15 mm, an oxygen permeability of less than or equal to 5 mL/(m²·24 h), and a water vapor permeability of less than or equal to 12 g/(m²·24 h). The separation layer has a surface tension of greater than or equal to 42 dynes, and a moisture content of less than or equal to 5.5 wt %.

The present disclosure further provides a preparation method of the heat-sealing barrier cellulose film. In the present disclosure, the preparation method features simple operations, wide sources of preparation raw materials, and low cost, and is suitable for industrial production.

### DETAILED DESCRIPTION OF THE EMBODIMENTS

The present disclosure provides a heat-sealing barrier cellulose film, including a separation layer, a regenerated cellulose support layer, and an adhesive layer that are laminated in sequence.

In the present disclosure, the separation layer is prepared from a barrier coating including a PVDC emulsion, a first anti-sticking agent, and water. In a specific example, the PVDC emulsion is preferably purchased from Solvay, USA. The PVDC emulsion has a solid content of preferably 30% to 45%, more preferably 35% to 40%. The first anti-sticking agent is preferably one or two selected from the group consisting of a wax anti-sticking agent and a silica powder anti-sticking agent; the wax anti-sticking agent is preferably Poligen WE-1 (BASF wax emulsion); and the first anti-sticking agent has a particle size of preferably 100 nm to 300 nm, more preferably 150 nm to 200 nm. The water includes preferably demineralized water. The PVDC emulsion and the first anti-sticking agent in the barrier coating are at a mass ratio of preferably 100:(1-3), more preferably 100:(1.5-2.5), and even more preferably 100:2.

In the present disclosure, a preparation method of the barrier coating includes preferably the following steps: mixing the PVDC emulsion, the first anti-sticking agent, and water to obtain the barrier coating. The mixing includes preferably: premixing the first anti-sticking agent with the water, and then remixing an obtained first anti-sticking agent solution with the PVDC emulsion. The premixing is conducted at preferably 500 r/min to 1,000 r/min, more preferably 700 r/min to 800 r/min for preferably 5 min to 15 min, more preferably 10 min under preferably a room temperature. The remixing is conducted at preferably 60 r/min to 120 r/min, more preferably 80 r/min to 100 r/min for preferably 15 min to 25 min, more preferably 20 min under preferably a room temperature. The separation layer has a thickness of preferably 2 μm to 7 μm, more preferably 3 μm to 6 μm, and even more preferably 4 μm to 5 μm.

In the present disclosure, the adhesive layer is prepared from an adhesive coating including an emulsion, a second anti-sticking agent, and water, and the emulsion includes an acrylate emulsion and/or a polyurethane emulsion. The optional type and particle size of the second anti-sticking agent are preferably the same as those of the first anti-sticking agent, and will not be repeated here. In a specific example, the acrylate emulsion is preferably a DSM water-based acrylate emulsion. The acrylate emulsion has a solid content of preferably 30% to 45%, more preferably 35% to 40%. The water includes preferably demineralized water. The acrylate emulsion and the second anti-sticking agent in the adhesive coating are at a mass ratio of preferably 100:(0.5-1.5), more preferably 100:(0.8-1.2), and even more preferably 100:1. A preparation method of the adhesive coating includes preferably the following steps: mixing the acrylate emulsion, the second anti-sticking agent, and water to obtain the adhesive coating. The mixing includes preferably: premixing the second anti-sticking agent with the water, and then remixing an obtained second anti-sticking agent solution with the acrylate emulsion. The premixing is conducted at preferably 500 r/min to 1,000 r/min, more preferably 700 r/min to 800 r/min for preferably 5 min to 15 min, more preferably 10 min under preferably a room temperature. The remixing is conducted at preferably 60 r/min to 120 r/min, more preferably 80 r/min to 100 r/min for preferably 15 min to 25 min, more preferably 20 min under preferably a room temperature. The adhesive layer has a thickness of preferably 4 μm to 7 μm, more preferably 4.5 μm to 6.5 μm, and even more preferably 5 μm to 6 μm.

In the present disclosure, the regenerated cellulose support layer has a weight of preferably (30-60) g/m², more preferably (35-55) g/m², and even more preferably (40-50) g/m²; and the regenerated cellulose support layer has a thickness of preferably 20 μm to 40 μm, more preferably 27 μm to 35 μm.

In the present disclosure, the regenerated cellulose support layer, the separation layer, and the adhesive layer in the heat-sealing barrier cellulose film are at a mass ratio of preferably (77-87):(4-8):(9-15), more preferably (80-85):(5-7):(10-14), and even more preferably (82-83):(6-6.5):(12-13). The heat-sealing barrier cellulose film has a moisture content of preferably 5% to 6%, more preferably 5.2% to 5.8%, even more preferably 5.4% to 5.5%.

The present disclosure further provides a preparation method of the heat-sealing barrier cellulose film, including the following steps:

coating both sides of the regenerated cellulose support layer with the barrier coating and the adhesive coating to form the separation layer and the adhesive layer, respectively, to obtain the heat-sealing barrier cellulose film.

In the present disclosure, unless otherwise specified, all raw material components are commercially available products well known to persons skilled in the art.

In the present disclosure, there is no special limitation on a preparation method of the regenerated cellulose support layer, and a preparation method well known to those skilled in the art can be used. Specifically, the preparation method is such as a carbon disulfide viscose method, a preparation method of a regenerated cellulose film disclosed in the literature (JIA Xiangjuan. NMMO/H₂O solution method in preparing high-adsorption regenerated cellulose material [D]. Shaanxi University of Science and Technology.), or a method for directly dissolving cellulose through ionic liquid and producing a regenerated cellulose film (the method is jointly developed by the Chinese Academy of Sciences and Shandong Henglian New Material Co., Ltd., and has already realized industrial production).

In a specific example of the present disclosure, the regenerated cellulose support layer is preferably produced by the carbon disulfide viscose method, which specifically includes the following steps: subjecting a cellulose raw material to alkalization and yellowing to obtain cellulose xanthate, namely a viscose stock solution; and spraying the viscose stock solution into a film, and then placing the film in an acid coagulation regeneration bath to allow acid coagulation regeneration to obtain a regenerated cellulose film. The cellulose raw material includes preferably cotton pulp, softwood pulp, or hardwood pulp. The alkalization is conducted with a lye, which includes preferably a sodium hydroxide solution; the lye has a concentration of preferably 17.5 wt % to 18.5 wt %, more preferably 18 wt %; the alkalization is conducted at preferably 45° C. to 65° C., more preferably 50° C. to 60° C. for preferably 10 min to 30 min, more preferably 15 min to 25 min; and during the alkalization, cellulose and sodium hydroxide react to generate alkali cellulose. A yellowing agent is preferably CS₂; the alkali cellulose and the yellowing agent are at a mass ratio of preferably 1:(0.25-0.32) (based on a dosage at 20° C.), more preferably 1:0.3; the yellowing is conducted at an initial temperature of preferably 20° C. to 30° C., more preferably 25° C. for preferably 30 min to 60 min, more preferably 40 min to 50 min. The acid coagulation regeneration bath includes preferably dilute sulfuric acid or a dilute sulfuric acid-sodium sulfate mixed solution; the dilute sulfuric acid has a concentration of preferably 10 wt % to 18 wt %, more preferably 12 wt % to 15 wt %; and in the dilute sulfuric acid-sodium sulfate mixed solution, the dilute sulfuric acid (namely H₂SO₄/H₂O) has a concentration of preferably 10 wt % to 18 wt %, more preferably 12 wt % to 15 wt %, and sodium sulfate has a concentration of preferably 230 g/L to 260 g/L, more preferably 245 g/L to 255 g/L. The viscose stock solution preferably enters the acid coagulation regeneration bath through a jet slot former to conduct the acid coagulation regeneration.

In the present disclosure, the regenerated cellulose film is sequentially subjected to pretreatment and softening and anti-sticking treatment to obtain the regenerated cellulose support layer.

In the present disclosure, the pretreatment includes preferably: subjecting the regenerated cellulose film sequentially to first water washing, desulfurization, second water washing, bleaching, dechlorination, and third water washing. The first water washing, the second water washing, and the third water washing are independently conducted preferably 1 to 6 times, more preferably 2 to 4 times. The desulfurization is preferably conducted using a lye, and the lye has a concentration of preferably 1.5 g/L to 3.5 g/L, more preferably 2 g/L to 3 g/L; and the lye includes preferably an aqueous solution of sodium hydroxide. A bleaching agent includes preferably sodium hypochlorite, hydrogen peroxide, or ozone, more preferably the sodium hypochlorite, with a concentration of preferably 1 g/L to 4 g/L, more preferably 1.5 g/L to 2.5 g/L. The dechlorination includes preferably washing with demineralized water.

In the present disclosure, a softening agent-anti-sticking agent aqueous dispersion used in the softening and anti-sticking treatment includes a softening agent, an anti-sticking agent, and water; the softening agent includes preferably a polyol, more preferably triethylene glycol or glycerin; the anti-sticking agent includes preferably nano-silica; and the anti-sticking agent has a particle size of preferably 5 nm to 600 nm, more preferably 80 nm to 100 nm. The softening agent and the anti-sticking agent are at a mass ratio of preferably (30-50):(1.5-5), more preferably (35-45):(2-4.5), further preferably (40-45):(3-4). The water is preferably demineralized water. The softening agent in the softening agent-anti-sticking agent aqueous dispersion has a concentration of preferably 30 g/L to 50 g/L, more preferably 35 g/L to 45 g/L, and even more preferably 40 g/L to 45 g/L. There is no particular limitation on a dosage of the softening agent-anti-sticking agent aqueous dispersion, as long as the wet regenerated cellulose film can be submerged. The softening and anti-sticking treatment is conducted at preferably 30° C. to 70° C., more preferably 45° C. to 55° C. for preferably 10 s to 20 s, more preferably 12 s to 16 s.

In the present disclosure, the regenerated cellulose film obtained after the softening and anti-sticking treatment is preferably subjected to drying and winding in sequence to obtain the regenerated cellulose support layer. The drying is conducted at preferably 100° C. to 150° C., more preferably 120° C. to 140° C. for preferably 20 s to 80 s, more preferably 40 s to 50 s. There is no special limitation on the winding, and a winding operation well known to those skilled in the art can be used.

In the present disclosure, both sides of the regenerated cellulose support layer are simultaneously coated with the barrier coating and the adhesive coating to form the separation layer and the adhesive layer, respectively, to obtain the heat-sealing barrier cellulose film.

In the present disclosure, a process of coating the both sides of the regenerated cellulose support layer simultaneously includes preferably the following steps: pumping the barrier coating and the adhesive coating into a first coating tank and a second coating tank by a pneumatic diaphragm pump, respectively, and then coating the both sides of the regenerated cellulose support layer simultaneously by an anilox roller. The anilox roller has an operating speed of preferably 70 m/min to 95 m/min, more preferably 75 m/min to 90 m/min, and even more preferably 80 m/min to 85 m/min. The anilox roller of the barrier coating has a mesh number of preferably 100 mesh to 250 mesh, more preferably 150 mesh to 200 mesh, and the barrier coating has a dry coating weight of preferably (3-5) g/m², more preferably (3.5-4.5) g/m², and even more preferably 4 g/m². The anilox roller of the adhesive coating has a mesh number of preferably 100 mesh to 180 mesh, more preferably 130 mesh to 150 mesh, and the adhesive coating has a dry coating weight of preferably (4-7) g/m², more preferably (4.5-6.5) g/m², and even more preferably (5-6) g/m².

In the present disclosure, after the both sides of the regenerated cellulose support layer are coated simultaneously, the wet heat-sealing barrier cellulose film is preferably subjected to cooling and winding after drying to obtain the heat-sealing barrier cellulose film. The drying includes preferably first drying and second drying in sequence. In the present disclosure, the first drying includes infrared drying conducted at preferably 60° C. to 80° C., more preferably 70° C. for preferably 1.2 s to 1.8 s, more preferably 1.4 s to 1.5 s. The second drying is conducted at preferably 60° C. to 120° C., more preferably 85° C. to 120° C. The second drying includes preferably horizontal drying; the horizontal drying is divided into eight drying zones that are successively recorded as a first drying zone to an eighth drying zone. The first drying zone has a temperature of preferably 85° C. to 95° C., more preferably 90° C. for preferably 2.7 s to 3.2 s, more preferably 2.8 s to 3.0 s. The second drying zone has a temperature of preferably 95° C. to 105° C., more preferably 100° C. for preferably 2.7 s to 3.2 s, more preferably 2.8 s to 3.0 s. The third drying zone has a temperature of preferably 105° C. to 115° C., more preferably 110° C. for preferably 2.7 s to 3.2 s, more preferably 2.8 s to 3.0 s. The fourth drying zone has a temperature of preferably 105° C. to 120° C., more preferably 110° C. to 115° C. for preferably 2.7 s to 3.2 s, more preferably 2.8 s to 3.0 s. The fifth drying zone has a temperature of preferably 95° C. to 105° C., more preferably 100° C. for preferably 2.7 s to 3.2 s, more preferably 2.8 s to 3.0 s. The sixth drying zone has a temperature of preferably 85° C. to 100° C., more preferably 90° C. to 95° C. for preferably 2.7 s to 3.2 s, more preferably 2.8 s to 3.0 s. The seventh drying zone has a temperature of preferably 80° C. to 98° C., more preferably 90° C. to 95° C. for preferably 2.7 s to 3.2 s, more preferably 2.8 s to 3.0 s. The eighth drying zone has a temperature of preferably 85° C. to 95° C., more preferably 88° C. to 93° C. for preferably 2.7 s to 3.2 s, more preferably 2.8 s to 3.0 s. During the drying, a heat-sealing barrier surface of the wet heat-sealing barrier cellulose film is on a bottom, while the adhesive layer is on a top. During the drying, due to differences in emulsion properties and dry coating weight of the both sides of the regenerated cellulose support layer, the regenerated cellulose support layer may be curled toward one side during the drying, such that the coating cannot be done normally. In the first drying and horizontal drying, the temperature and operating speed of the eight drying zones are controlled to balance a stress on both sides of the regenerated cellulose support layer, so as to achieve smooth winding. A cooling lamination roller for the cooling and winding has a temperature of preferably 20° C. to 25° C., more preferably 22° C. to 23° C.

The present disclosure further provides use of the heat-sealing barrier cellulose film or a heat-sealing barrier cellulose film prepared by the preparation method in the field of packaging. In the present disclosure, the heat-sealing barrier cellulose film can be directly heat-pressed with paper products, thus meeting the requirements of bonding strength in coated paper to a certain extent. The heat-sealing barrier cellulose film shows high moisture resistance and oxygen resistance, and exerts excellent fragrance retention, freshness retention, and moisture resistance. The heat-sealing barrier cellulose film can also be heat-pressed by itself to form a packaging bag, and the packaging bag exhibits a high edge-sealing strength and shows a desirable application prospect as a packaging material.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the protection scope of the present disclosure.

### Example 1

(1) Cotton pulp and wood pulp with a mass ratio of 1:3 were mixed evenly; an obtained mixed slurry was mixed evenly with a sodium hydroxide solution having a concentration of 17.5 wt % at a volume ratio of 1:28, and then alkalized at 45° C. for 30 min; obtained alkali cellulose and CS₂ were uniformly mixed according to a mass ratio of 1:0.28, and then yellowed at 20° C. for 60 min to obtain a fiber viscose stock solution; the fiber viscose stock solution was added into dilute sulfuric acid (12 wt %) through a jet slot former, and then subjected to acid coagulation at 50° C. to obtain regenerated cellulose. The regenerated cellulose was sequentially washed with water, desulfurized in a lye with a concentration of 1.5 g/L at 80° C., washed with water, bleached in a sodium hypochlorite solution with a pH value of 9, dechlorinated in demineralized water at room temperature, and washed with water. An obtained product was immersed in a softening bath, softened in a triethylene glycol-nano-silica aqueous dispersion at 50° C. for 8 s, dried at 130° C., adjusted to a proper humidity and wound to obtain a regenerated cellulose support layer with a moisture content of 6.0% and a weight of 30 g/m². In the triethylene glycol-nano-silica aqueous dispersion, the triethylene glycol had a concentration of 30 g/L, and the nano-silica had a particle size of 80 nm and a concentration of 1.5 g/L.

(2) Demineralized water and a wax anti-sticking agent (BASF wax emulsion, Poligen WE-1) were stirred at 1,000 r/min for 10 min at a mass ratio of 1:0.3, an obtained wax anti-sticking agent solution was mixed with a DSM water-based acrylate emulsion and stirred at 200 r/min for 10 min to obtain an adhesive coating, which was stored at 200 r/min for later use. In the adhesive coating, the acrylate emulsion and the wax anti-sticking agent were at a mass ratio of 100:0.5; the adhesive coating had a solid content of 42%, and was stored by stirring evenly at 200 r/min.

(3) The demineralized water and the wax anti-sticking agent (BASF wax emulsion, Poligen WE-1) were stirred at 1,000 r/min for 10 min at a mass ratio of 1:0.3, the obtained wax anti-sticking agent solution was mixed with a PVDC emulsion (purchased from Solvay, USA) and stirred at 200 r/min for 10 min to obtain a barrier coating, which was stored at 200 r/min for later use. In the barrier coating, the PVDC emulsion and the wax anti-sticking agent were at a mass ratio of 100:1.5; the barrier coating had a solid content of 40%.

(4) Simultaneous double-sided coating: the barrier coating and the adhesive coating were pumped into a first coating tank and a second coating tank by a pneumatic diaphragm pump, respectively, and the regenerated cellulose support layer was coated simultaneously on both sides by an anilox roller to obtain a wet heat-sealing barrier cellulose film. The anilox roller had an operating speed of 90 m/min; the anilox roller of the barrier coating had a mesh number of 250 mesh, and the barrier coating had a dry coating weight of 2.5 g/m²; the anilox roller of the adhesive coating had a mesh number of 150 mesh, and the adhesive coating had a dry coating weight of 6 g/m².

(5) The wet heat-sealing barrier cellulose film was subjected to infrared drying at 60° C. for 1.3 s, dried in a drying tunnel by horizontal drying with heating through hot air, and cooled and wound with a cooling lamination roller at 20° C. to obtain the heat-sealing barrier cellulose film; where
conditions of the horizontal drying were shown in Table 1:

TABLE 1
Horizontal drying conditions

| | First | Second | Third | Fourth | Fifth | Sixth | Seven | Eighth |
|---|---|---|---|---|---|---|---|---|
| | drying | drying | drying | drying | drying | drying | drying | drying |
| | zone | zone | zone | zone | zone | zone | zone | zone |
| Temperature/° C. | 90 | 100 | 110 | 110 | 105 | 95 | 90 | 88 |
| Time/s | 2.7 | 2.7 | 2.7 | 2.8 | 2.8 | 2.8 | 2.7 | 2.7 |

According to the test method of GB/T24695-2009, performance test results of the heat-sealing barrier cellulose film were as follows, including: a weight of 40 g/m², a longitudinal tensile strength of 36.85 N/15 mm, a longitudinal elongation of 18.36%, a bonding strength of the adhesive layer to a paper product of 6.58 N/15 mm, a self-adhesion strength of the adhesive layer of 7.3 N/15 mm, an oxygen permeability of 5 mL/(m²·24 h), and a water vapor permeability of 12 g/(m²·24 h). The separation layer had a surface tension of 42 dynes, and a moisture content of 5.2 wt %.

### Example 2

According to the method of Example 1, a heat-sealing barrier cellulose film was prepared. This example differed from Example 1 in that:
in step (1), the regenerated cellulose support layer had a weight of 40 g/m², the triethylene glycol had a concentration of 40 g/L, and the nano-silica had a concentration of 3 g/L;
in step (2), the acrylate emulsion and the wax anti-sticking agent in the adhesive coating were at a mass ratio of 100:1; the adhesive coating had a solid content of 42%;
in step (3), the PVDC emulsion and the wax anti-sticking agent in the barrier coating were at a mass ratio of 100:1; the barrier coating had a solid content of 40%;
in step (4), the anilox roller had an operating speed of 80 m/min; the anilox roller of the barrier coating had a mesh number of 200 mesh, and the barrier coating had a dry coating weight of 3 g/m²; the anilox roller of the adhesive coating had a mesh number of 100 mesh, and the adhesive coating had a dry coating weight of 6.5 g/m²; and
in step (5), the infrared drying was conducted at 70° C. for 1.5 s, and the cooling lamination roller was at 23° C.

According to the test method of GB/T24695-2009, performance test results of the heat-sealing barrier cellulose film were as follows, including: a weight of 50 g/m², a longitudinal tensile strength of 52.63 N/15 mm, a longitudinal elongation of 22.34%, a bonding strength of the adhesive layer to a paper product of 7.21 N/15 mm, a self-adhesion strength of the adhesive layer of 7.8 N/15 mm, an oxygen permeability of 3.8 mL/(m²·24 h), and a water vapor permeability of 9 g/(m²·24 h). The separation layer had a surface tension of 42 dynes, and a moisture content of 5.5 wt %.

### Example 3

According to the method of Example 1, a heat-sealing barrier cellulose film was prepared. This example differed from Example 1 in that:
in step (1), the regenerated cellulose support layer had a weight of 50 g/m², the triethylene glycol had a concentration of 50 g/L, and the nano-silica had a concentration of 5 g/L;
in step (2), the acrylate emulsion and the wax anti-sticking agent in the adhesive coating were at a mass ratio of 100:1.5; the adhesive coating had a solid content of 42%;
in step (3), the PVDC emulsion and the wax anti-sticking agent in the barrier coating were at a mass ratio of 100:2; the barrier coating had a solid content of 40%;
in step (4), the anilox roller had an operating speed of 75 m/min; the anilox roller of the barrier coating had a mesh number of 150 mesh, and the barrier coating had a dry coating weight of 4 g/m²; the anilox roller of the adhesive coating had a mesh number of 50 mesh, and the adhesive coating had a dry coating weight of 6 g/m²; and
in step (5), the infrared drying was conducted at 70° C. for 1.6 s, and the cooling lamination roller was at 25° C.; where conditions of the horizontal drying were shown in Table 2:

TABLE 2
Horizontal drying conditions

| | First | Second | Third | Fourth | Fifth | Sixth | Seven | Eighth |
|---|---|---|---|---|---|---|---|---|
| | drying | drying | drying | drying | drying | drying | drying | drying |
| | zone | zone | zone | zone | zone | zone | zone | zone |
| Temperature/° C. | 95 | 105 | 115 | 120 | 110 | 100 | 95 | 93 |
| Time/s | 3.2 | 3.2 | 3.2 | 3.3 | 3.3 | 3.3 | 3.2 | 3.2 |

According to the test method of GB/T24695-2009, performance test results of the heat-sealing barrier cellulose film were as follows, including: a weight of 60 g/m², a longitudinal tensile strength of 73.26 N/15 mm, a longitudinal elongation of 43.65%, a bonding strength of the adhesive layer to a paper product of 7.83 N/15 mm, a self-adhesion strength of the adhesive layer of 8.31 N/15 mm, an oxygen permeability of 2.8 mL/(m²·24 h), and a water vapor permeability of 7 g/(m²·24 h). The separation layer had a surface tension of 42 dynes, and a moisture content of 5.4 wt %.

### Comparative Example 1

According to the method of Example 3, a heat-sealing barrier cellulose film was prepared. This comparative example differed from Example 1 in that:

in step (1), the regenerated cellulose support layer had a weight of 50 g/m², the triethylene glycol had a concentration of 50 g/L, and the nano-silica had a concentration of 5 g/L;
the adhesive coating in step (2) was replaced by the barrier coating in step (3);
in step (4), the barrier coating was coated on both sides; the anilox roller had a mesh number of 200 mesh, and the dry coating weight on both sides was 2.5 g/m²; and
in step (5), the infrared drying was conducted at 80° C. for 1.6 s.

According to the test method of GB/T24695-2009, performance test results of the heat-sealing barrier cellulose film were as follows, including: a weight of 60 g/m², a longitudinal tensile strength of 70.26 N/15 mm, a longitudinal elongation of 41.65%, a bonding strength of the adhesive layer to a paper product of 0 N/15 mm, a self-adhesion strength of the adhesive layer of 1.9 N/15 mm, an oxygen permeability of 6 mL/(m²·24 h), and a water vapor permeability of 25 g/(m²·24 h). The two separation layers both had a surface tension of 42 dynes, and a moisture content of 5.4 wt %.

By comparing Example 3 with Comparative Example 1, it was seen that: compared with the technology of the present disclosure, the heat-sealing barrier cellulose film prepared in Comparative Example 1 had neither the adhesive strength with paper products nor its own adhesive strength that met the requirements of coated paper-based composite products, and was not suitable for special application scenarios.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A heat-sealing barrier cellulose film, comprising a separation layer, a regenerated cellulose support layer, and an adhesive layer that are laminated in sequence; wherein
the separation layer is prepared from a barrier coating comprising a polyvinylidene chloride (PVDC) emulsion, a first anti-sticking agent, and water; and
the adhesive layer is prepared from an adhesive coating comprising an emulsion, a second anti-sticking agent, and water, and the emulsion comprises an acrylate emulsion and/or a polyurethane emulsion.

2. The heat-sealing barrier cellulose film according to claim 1, wherein the regenerated cellulose support layer, the separation layer, and the adhesive layer are at a mass ratio of (77-87):(4-8):(9-15).

3. The heat-sealing barrier cellulose film according to claim 1, wherein the heat-sealing barrier cellulose film has a moisture content of 5% to 6%.

4. The heat-sealing barrier cellulose film according to claim 1, wherein the PVDC emulsion and the first anti-sticking agent in the barrier coating are at a mass ratio of 100:(1-3).

5. The heat-sealing barrier cellulose film according to claim 4, wherein the PVDC emulsion has a solid content of 30% to 45%.

6. The heat-sealing barrier cellulose film according to claim 4, wherein the first anti-sticking agent is one or two selected from the group consisting of a wax anti-sticking agent and a silica powder anti-sticking agent; and the first anti-sticking agent has a particle size of 100 nm to 300 nm.

7. The heat-sealing barrier cellulose film according to claim 1, wherein the separation layer has a thickness of 2 μm to 7 μm.

8. The heat-sealing barrier cellulose film according to claim 1, wherein the acrylate emulsion and the second anti-sticking agent in the adhesive coating are at a mass ratio of 100:(0.5-1.5).

9. The heat-sealing barrier cellulose film according to claim 8, wherein the acrylate emulsion has a solid content of 30% to 45%.

10. The heat-sealing barrier cellulose film according to claim 8, wherein the second anti-sticking agent is one or two selected from the group consisting of a wax anti-sticking agent and a silica powder anti-sticking agent; and the second anti-sticking agent has a particle size of 100 nm to 300 nm.

11. The heat-sealing barrier cellulose film according to claim 1, wherein the adhesive layer has a thickness of 4 μm to 7 μm.

12. The heat-sealing barrier cellulose film according to claim 1, wherein the regenerated cellulose support layer has a weight of 30 g/m² to 60 g/m².

13. The heat-sealing barrier cellulose film according to claim 12, wherein the regenerated cellulose support layer has a thickness of 20 μm to 40 μm.

14. A preparation method of the heat-sealing barrier cellulose film according to claim 1, comprising the following steps:
coating both sides of the regenerated cellulose support layer with the barrier coating and the adhesive coating to form the separation layer and the adhesive layer, respectively, to obtain the heat-sealing barrier cellulose film.

15. The preparation method according to claim 14, wherein a process of coating both sides of the regenerated cellulose support layer simultaneously comprises the following steps: pumping the barrier coating and the adhesive coating into a first coating tank and a second coating tank by a pneumatic diaphragm pump, respectively, and then coating both sides of the regenerated cellulose support layer simultaneously by an anilox roller.

16. The preparation method according to claim 15, wherein the anilox roller has an operating speed of 70 m/min to 95 m/min;
the anilox roller of the barrier coating has a mesh number of 100 mesh to 250 mesh, and the barrier coating has a dry coating weight of 3 g/m² to 5 g/m²; and
the anilox roller of the adhesive coating has a mesh number of 100 mesh to 180 mesh, and the adhesive coating has a dry coating weight of 4 g/m² to 7 g/m².

17. The preparation method according to claim 14, further comprising the following steps after both sides of the regenerated cellulose support layer are coated simultaneously: cooling and winding an obtained wet heat-sealing barrier cellulose film after drying.

18. The preparation method according to claim 17, wherein the drying comprises first drying and second drying in sequence; the first drying comprises infrared drying conducted at 60° C. to 80° C. for 1.2 s to 1.8 s; and the second drying is conducted at 60° C. to 120° C.

19. The preparation method according to claim 18, wherein the second drying refers to horizontal drying; the horizontal drying is divided into eight drying zones that are successively recorded as a first drying zone to an eighth drying zone; the first drying zone has a temperature of 85° C. to 95° C., the second drying zone has a temperature of 95° C. to 105° C., the third drying zone has a temperature of 105° C. to 115° C., the fourth drying zone has a temperature of 105° C. to 120° C., the fifth drying zone has a temperature of 95° C. to 105° C., the sixth drying zone has a temperature of 85° C. to 100° C., the seventh drying zone has a temperature of 80° C. to 98° C., and the eighth drying zone has a temperature of 85° C. to 95° C.

20. A method for preparing a packaging material using the heat-sealing barrier cellulose film according to claim 1.
